(19) United States
(12) Patent Application Publication
(10) Pub. No.: US 2013/0232552 A1
(43) Pub. Date: Sep. 5, 2013

(54) Automatic Context Sharing with Privacy

(71) Applicants: Alice Jane Bernheim Brush, Bellevue, WA (US); Timothy Scott Saponas, Woodinville, WA (US); Asta Roseway, Clyde Hill, WA (US); James William Scott, Cambridge (GB); Ryder B. Ziola, Edmonton (CA); Aman Kansal, Redmond, WA (US); Paul R. Johns, Tacoma, WA (US); Gregory R. Smith, Bellevue, WA (US)

(72) Inventors: Alice Jane Bernheim Brush, Bellevue, WA (US); Timothy Scott Saponas, Woodinville, WA (US); Asta Roseway, Clyde Hill, WA (US); James William Scott, Cambridge (GB); Ryder B. Ziola, Edmonton (CA); Aman Kansal, Redmond, WA (US); Paul R. Johns, Tacoma, WA (US); Gregory R. Smith, Bellevue, WA (US)

(73) Assignee: MICROSOFT CORPORATION, Redmond, WA (US)

(21) Appl. No.: 13/409,905

(22) Filed: Mar. 1, 2012

(51) Int. Cl. G06F 21/00

(52) U.S. Cl. 726/4

(57) ABSTRACT

The subject disclosure is directed towards a technology by which a computing device user may share context-related information (e.g., including current activity) with other recipient machines. A requestor may request to peek at a user's context, and if the requestor is valid (pre-approved by the user), a response based on context-related information is sent, which may be via a cloud service. The response may be filtered and/or adjusted based upon the identity of the requestor and other information associated with that identity, e.g., filtering criteria set by the user. Also described is notifying the user of the peek request, and logging information corresponding to the request and response. A broadcast message may also be sent by the device to share context without waiting for a peek request.

### BACKGROUND

There are many situations in which a computing device user wants to know something about another person's current status, or context. In many of these situations it is also helpful to determine the context of another person without disturbing him or her (e.g. for safety concerns or to avoid interrupting). For example, one person may want to call another person on a mobile device to see that other person is headed home, but prefers not to do so when there is a good chance the other person is driving. Other times it is desirable to know the context of a person quickly and automatically, without a telephone call or text communication. For example, a parent may want to know when the children are home from school, but cannot interrupt an important meeting to place a phone call or text message to them, which may go unanswered in any event. A worker may want to know where coworkers are when he or she is the only one on time for a meeting.

However, location tracking devices and mobile device-based programs provide information that users may or may not want to share. For example, a husband may not mind that his wife knows his current location, but does not want anyone else to know. A worker may be fine with her coworkers knowing her current location on the company campus during working hours, but does not want to share location information at other times. Known solutions do not handle such concepts and scenarios while respecting user privacy concerns.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a context sharing service receives context data corresponding to a device user's activity, processes the context data into context-related information based upon an identity of a valid recipient, and sends the context-related information to a recipient machine. The context sharing service may send the context-related information to the recipient machine in response to a peek request from the recipient machine, or in response to a broadcast request from the device. The context sharing service also takes action to indicate that the context-related information was sent, comprising providing a notification for output by the device and/or recording information in an audit data structure.

In one aspect, the context data is filtered into filtered context-related data based upon filtering criteria, which may include location-related, time-related, and/or device-related criteria. A response or message based upon the filtered context-related data may be sent. The response or message may be based at least in part on whether the request is associated with reciprocal context-related information.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components configured to share context-related information between computing devices according to one example embodiment.

FIG. 2 is a block diagram representing example components of a context sharing program and a context sharing service according to one example embodiment.

FIG. 3 is a flow diagram representing example steps that may be taken by a device to provide context data to a remote context sharing service according to one example embodiment.

FIG. 4 is a flow diagram representing example steps that may be taken by a remote context sharing service to return context-related information in response to a peek request according to one example embodiment.

FIG. 5 is a flow diagram representing example steps that may be taken by a remote context sharing service to handle various requests from a client device according to one example embodiment.

FIGS. 6A-8B comprise example representations of various user interfaces and other output on a display screen of an example mobile device to facilitate context sharing according to one example embodiment.

FIG. 9 is a block diagram representing an example non-limiting computing system or operating environment, e.g., in the example of a mobile phone device, in which one or more aspects of various embodiments described herein can be implemented.

### DETAILED DESCRIPTION

Various aspects of the technology described herein are generally directed towards a technology by which a device user allows other pre-approved users and/or requesting entities to “peek” at the user's current context (e.g., status) in an automatic and controlled manner that respects user privacy. For example, a requestor can peek and obtain a context result that indicates that the peeked-at user is driving, walking, at home or at work, and so forth, as well as obtain calendar status, noise level around the device, any application in use (e.g. phone, game) and/or the like. As part of the peeking process, the peeked-at user is able to be notified as to who is peeking, thereby operating in a privacy respectful manner and avoiding non-consensual spying/stalking scenarios,

In one aspect, a user sets up peeking criteria, such as to control who can peek, as well as automatically controlling (filtering) the result based upon when the peek occurs, where the user's device is when the peek occurs, and so forth. Further, the type of device that is being peeked at, context from other users, and/or the actual current context may be factors in determining whether a user's context-related data is sent, and/or what the context-related data indicates.

It should be understood that any of the examples herein are non-limiting. For example, while a mobile device/smartphone are described in some of the examples herein, at least some of the concepts described herein are applicable to other computing systems, such as laptops and tablets, gaming consoles, dedicated positioning devices, automobile-based devices, construction equipment, military equipment, medical equipment, and even devices not typically considered mobile such as a desktop personal computer, appliances or the like. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and information sharing in general.

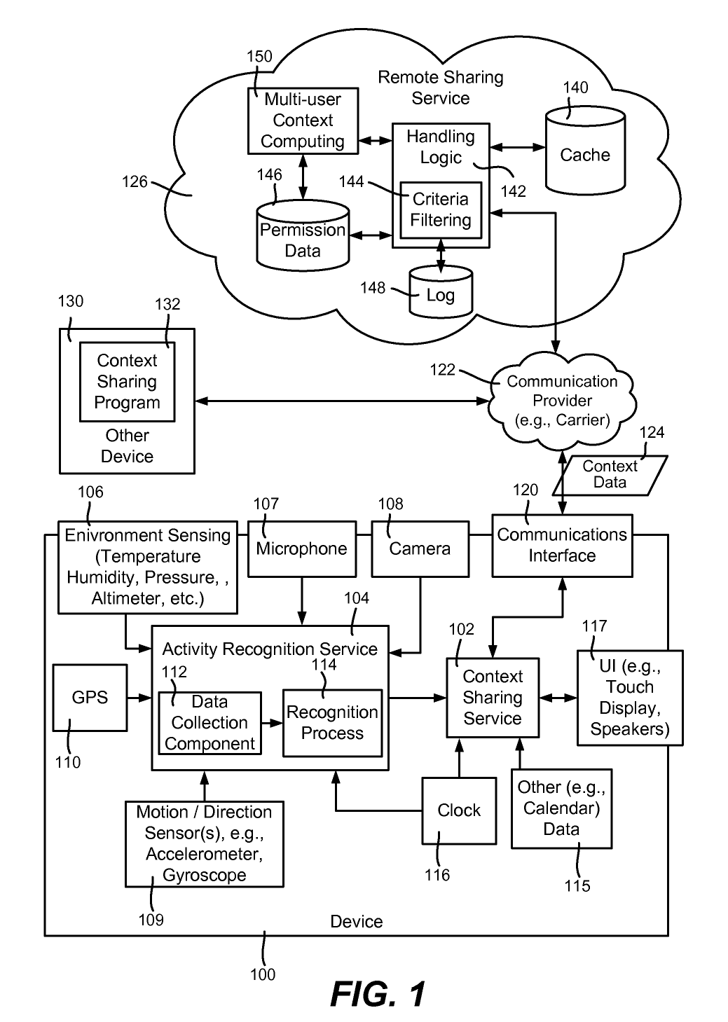

FIG. 1 is a block diagram showing various components in one example implementation. In general, a device 100 includes a context sharing service 102 (e.g., an application) that shares information about a user's current activity (e.g., driving, walking running, working, and so forth) with other users in an automatic, controlled and private manner as described herein.

In general, the (likely) current context of a user may be determined based upon input from any number of a plurality of device sensors that determines a user's likely activity, possibly along with other data (such as calendar data and/or task list data). As represented in FIG. 1, the device 100 includes an activity recognition service 104 (e.g., a human activity recognition program) that is configured to receive input directly or indirectly from sensors 106-110 that are available on the device 100. Example sensors that are illustrated include one or more current environmental condition- (e.g., weather) related sensors 106 (e.g., for measuring temperature, humidity, altitude and/or pressure), a microphone 107, a camera 108, one or more motion/direction-related sensors 109 (e.g., an accelerometer and/or gyroscope) and a GPS sensor 110. Any of the sensed data may be sampled, cached, pre-processed, averaged, reformatted and/or the like by the activity recognition service 104, or before being input by the activity recognition service 104. For example, the microphone input may be processed by a sound processing mechanism and/or the video input by an image processing mechanism, e.g., the sound processing mechanism may convert the audio to a particular format, or may sample the audio input into a digital fingerprint/set of audio features. The image processing mechanism may process one or more captured images (which may correspond to video) to identify certain features of the images. Any of these processing components may be external and coupled to the activity recognition service 104, or internal and incorporated into the activity recognition service 104.

Note that not all of the illustrated sensors may be present on a given device; one or more other sensors may be present instead of or in addition to those exemplified in FIG. 1. Further note that if present, at times a sensor may not be operational or reliable due to current conditions, however any prior knowledge obtained from that sensor may be used by the activity recognition service 104.

In general, the activity recognition service 104 includes a data collection component 112 that collects the various sensor-provided (and possibly other) data. This information is processed by recognition process 114 that determines the current user context, and makes that current context available to the context sharing program via a suitable interface. One human activity recognition background service on Windows® phones monitors the accelerometer and location stack to provide such data. Human activity recognition based upon such sensed data is well known, and thus is not described herein in detail. The activity or context status may also be explicitly specified by the user when they so desire. The user-entered status typically overrides the automatically inferred value except in special circumstances (e.g., such as where parents are monitoring their teenage children when driving to not allow making phone calls; when driving the teenagers may not be allowed to override their context to be an activity other than driving).

The context sharing service 102 inputs the current activity data and may package it as part of the peek context data in any suitable form for communication, possibly in conjunction with other data such as calendar and/or task list data 115, clock data 116 (e.g., a current timestamp) and/or user-provided data (obtained via a device user interface 117, which also represents a display, speakers, vibration mechanism, and/or the like for outputting information to the user). One example of user-provided data is to override a current context, e.g., a user may explicitly pin himself or herself to a context, for example, to indicate “driving” when actually stopped at a gas station. Users are also able to put themselves in a “no peeking” mode in which the device is seen as not available and people cannot peek at the context, e.g., acting with the same behavior as when the device is turned off.

Via a suitable communications interface 120 (which for example represents software, hardware and an antenna) and an appropriate provider 122 of cellular, 3G, 4G and/or Wi-Fi connectivity, the context data 124 (or some formatted, compressed and/or other encoded representation of the data) is sent to a remote peek-sharing service 126, e.g., a cloud-based service. As described below, this context data 124 may be pulled on demand in response to a request from the service 126, pushed from a user request or periodically or occasionally (e.g., send the data in anticipation of being needed) or on some other time schedule. In one example implementation, this may be accomplished in part by leveraging a notification service, such as the well-documented Windows® phone notification service.

While a common use case may be to have a single device such as a user's smartphone being the source of context data, the activity data used to determine context can be obtained from multiple devices, and the notifications to the user of peeking by others can also be through multiple devices. Such devices may be mobile devices that the user brings with them, e.g. a phone, laptop, or watch, or can be stationary devices in the environment that the user visits, e.g. a home Microsoft® XBOX® with a Kinect™ sensor that can detect the presence of users in the environment and identify them and their activities. In such cases, the sharing service may have to perform a further aggregation step in which activity data from multiple devices is combined into a single context notification. For example, one method for doing this is to determine which of a user's devices most recently detected the user's presence and use that device's activity data in preference to data from other devices which is not as up-to-date.

It should be noted that the cloud service is only one implementation. As can be readily appreciated, any of the functionality of the remote sharing service may be implemented locally on the device via similar components. Note however that such a local implementation may consume more device resources, as such a local implementation does not benefit from the remote cache that may significantly reduce communications with the device. As another alternative, instead of a cloud service, a remote computer such as a networked personal computer may perform some or all of the operations performed by the cloud service and send responses via email, SMS, notification protocols, upload responses to websites, and so forth.

Further, when a cloud sharing service or other networked device is used to cache context from multiple user devices, as represented via block 150 in FIG. 1, the service may also compute group contexts and/or also compute contexts that may be inferred only from multiple users' contexts. One example is group contexts for an entire family; (e.g., a family's status may be peeked as “on family vacation” as opposed to simply stating “at a vacation resort”). As an example of inferred contexts from multiple users, if Bob and Alice both have a context showing “in meeting on Project X,” their coworker may be shown the context for Bob as “meeting with Alice” and the coworker may use this information to join the meeting. The sharing service may also allow policies or filters that depend on multiple users. For example, an executive assistant may wish to show his context to be the same as that of his boss during work hours.

Returning to the example of FIG. 1, another (requesting) device 130 sends a request to peek at the user's context via a context sharing service 132, which reaches the cloud service 126. This other context sharing service 132 may be another instance of the same program as the context sharing service 102, or alternatively may be a separate program, such as an application configured to work on a different type of device. Note further that the request may be made through a different communication provider, although for simplicity in FIG. 1 the communication from the other device 130 is shown as being through the same provider 122.

Upon receiving the request, the remote sharing service sends a communication to pull the context data 124 from the device 100. In one implementation, the remote sharing service caches the context data 124 in a cache 140 for some timeframe, e.g., five minutes, so as to not communicate with the device 100 too often and drain its battery/incur costs if someone keeps requesting to peek at the user data. Thus, in general the pull operation only occurs when the cache is empty or stale.

The remote sharing service 126 includes handling logic 142 for handling the request as described herein, including performing criteria-based filtering 144. For example, based on the identity of the requestor and permissions data set by the peeked-at user of the device 100 and associated with the requestor identity, the response may be denied (e.g., the requestor is not known), filtered (the user is driving, but this requestor is only authorized to see the “driving” status and not the location), or adjusted for the requestor, (e.g., a coworker only receives “at work” or “not at work” response, whereas a spouse may see a different response).

A user may also set a reciprocity condition, that is, no response is sent (or no response that contains substantive context sent) unless the requestor similarly provides his or her context, possibly at a similar disclosure level (e.g., location given only if location received). The technology described herein thus facilitates the sharing of context rather than one-way “stalking”/spying scenarios, whereby the person peeking can also send (or may have to send) his or her own context information when requesting a peek, essentially trading context information with the peeked-at person.

As set forth above, the peeked-at user is also able to receive a notification that the peek request occurred. Further, in one implementation peek requests and corresponding response data are recorded (e.g., in a log 148 or other suitable data structure) so that the user may go back in time and audit the peeks that occurred previously. In addition to seeing who peeked and when, the user is also able to review his or her responses that were sent; for example, the user may change filtering criteria if he realizes from the responses that were sent that he is giving location data to coworkers after work hours and decides not to share such information. These various concepts comprise taking action to help protect privacy.

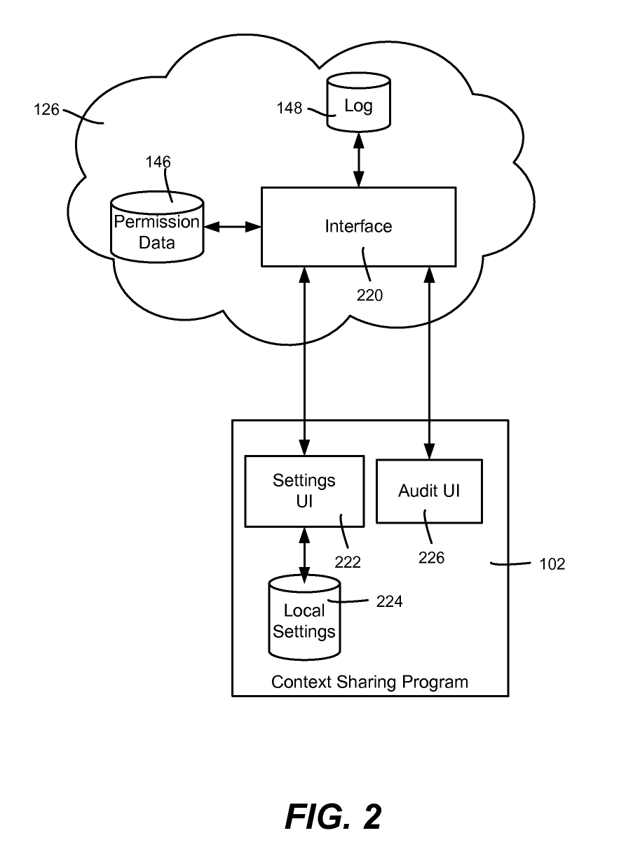

FIG. 2 shows how a user may interact with the remote sharing service 126 through a suitable interface 220 to interact with the permission data 146 and the log 148. For example, a user may interact via a settings user interface 222 of the context sharing service 102 to add or remove other user identities to the permissions data 146, and set the filtering criteria as to what amount of context each other user can see, where and when that user can see it, and so forth. As a more particular example, a user may set criteria that allows him as well as a caregiver to see his child's location and activity using the peeked-at device comprising a home Microsoft® XBOX® with a Kinect™ sensor only if the peek request occurs between 3:00 pm and 6:00 pm. A user may also set local settings 224, e.g., color schemes, icons and so forth that appear on the device.

FIG. 2 also shows an audit user interface 226 built into the context sharing service 102 by which the user may view (and delete) peek-related data in the log 148. Note that a user may use a different device for auditing, e.g., a user may have the context sharing program on her phone, yet prefer to interact with the audit UI via a suitable program on her personal computer. Thus, an identity with appropriate credentials may be needed to obtain access.

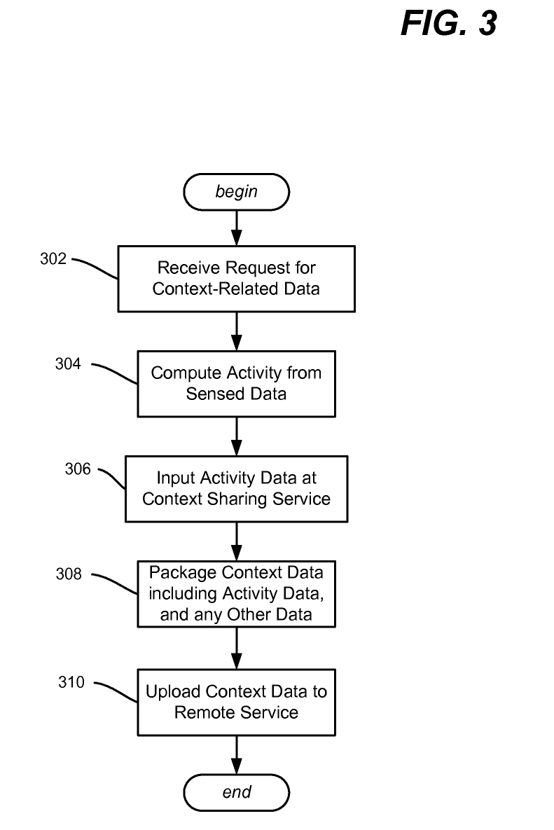

FIG. 3 is a flow diagram showing example steps performed by a peeked-at device, beginning at step 302 where a request to provide peek context data is received, e.g., from the cloud service. Note that step 302 also may occur via a user request, such as if the user wants to update the cache or broadcast the current context information (as described below).

Step 304 represents computing the current user activity from the sensed data. Steps 306 and 308 represent the context service inputting the activity data, and packaging the activity data along with possibly other context-related data into the context data. As described above, other such data may include a timestamp, calendar data, user data (e.g., overrides), and possibly other concepts such as user mood (if not determined via sensor sensing). At step 310, the context data is uploaded to the remote sharing service (or alternatively provided to a local component that operates as the sharing service).

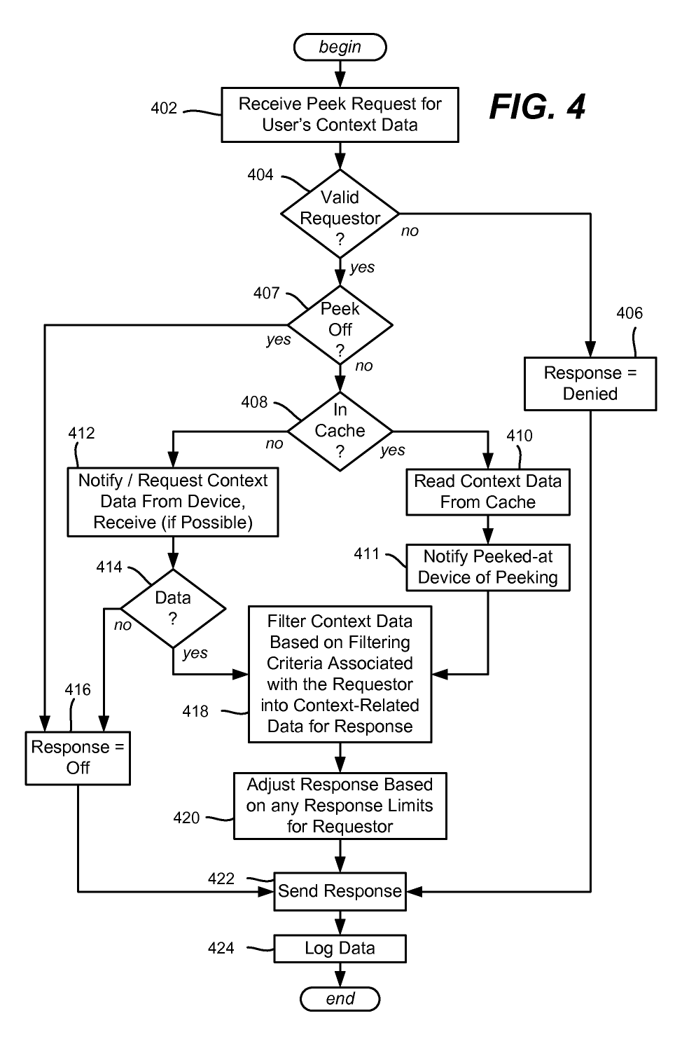

FIG. 4 is a flow showing example steps performed by an example implementation having a remote sharing service, beginning at step 402 when the request for a user's context data is received. Step 404 evaluates whether the request is from a valid requestor, e.g., corresponding to a known identity pre-approved by the user corresponding to this peek request. Note that one requestor may have many devices, and thus the concept of a single peek identity may be used so that a user does not have to authorize individual devices of each of his or her contacts that are allowed to peek. If not a valid requestor identity, a response may be returned via step 406 that basically indicates that the peek request was not able to be handled, for example either explicitly stating it was denied or by providing some other response such as “device off” to give the user plausible deniability. Note that it is alternatively feasible to not return a response to an invalid user, or to return one selectively, e.g., only the first time, only once per twenty-four hours, and so forth.

Step 407 represents determining whether the user has turned off the peek service. If so, step 407 branches to step 416 to basically indicate that peeking is not active at this time (which itself is a context).

Step 408 evaluates whether the context data is in the cache and is not stale (if not automatically evicted upon becoming stale). If so, the context data is read at step 410, the peeked-at device notified of the request at step 411 (unless notification is turned off, which a user may selectively do as described herein), and the process continues to step 418 as described below. Thus, in this example implementation, notification of the peek request occurs even if the context data is retrieved from the cache.

If not cached (or stale), step 408 branches to step 412 which represents requesting and receiving the context data from the device, e.g., in the pull mode described above. Notification of the peek request (unless turned off) may be included this communication at step 412, or may be sent in a separate communication. It is possible that the device is off or there is no communication with the device, as detected via step 414. If so, step 414 branches to step 416 to indicate that peeking is not active at this time, which is context data; (note that in this example, peeking turned off or device off returns the same message at step 416, however it is feasible to have different messages for peek off versus device off, providing more granular context). Otherwise, the device-provided context data is obtained, and the process continues to step 418.

Step 418 represents the filtering process for the requesting identity. In general, depending on the filtering criteria, various pieces of the context data may be removed. As described herein, virtually any appropriate criteria may be used in virtually any combination, including identity of requestor, class/grouping of requestor (e.g., spouse, child, parent, friend, coworker), time, location, device being peeked at, and so forth. The current context including activity may be used as filtering criteria, e.g., do not report the location to a coworker if the current activity is driving, but reporting location is okay if walking). Filtering may also be based in part upon the type of request, e.g., if the request was accompanied by reciprocal context information, that reciprocal context information may be used by the filter to decide what to provide in the response.

Step 420 represents adjusting the post-filtering context-related data into an appropriate response (which may be customized by the user) based upon any response limits set for the requestor (e.g., by identity or by class of requestor). For example, a user may limit a response to a coworker to either “at work” or “unknown location.” In this way, the user can participate in context sharing, yet limit what is seen so that the context-related data remains protected.

Step 422 represents sending the response. Step 424 represents logging data representing the response that was sent for later auditing purposes as described herein.

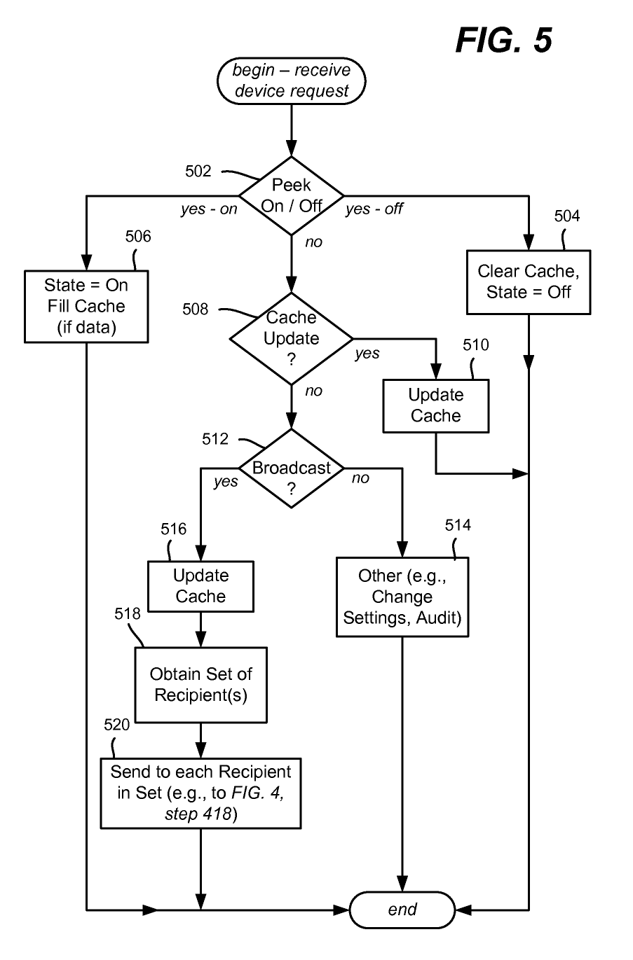

FIG. 5 is a flow diagram showing example steps when the user device contacts the sharing service, that is, without a peek request from another user being a trigger. One such request, represented as evaluated via step 502, is that the peek service is to be turned on or off at the service. If off, at step 504 the cache is cleared so as to not send any cached data in response to a peek, and the user state set to off (so as to not communicate unnecessarily). Step 506 handles the request to turn peeking on, which may be accompanied by current context data that fills the cache.

Step 508 represents a request to force a cache update, which may be by user request, or automatic, e.g., upon some significant context state change. For example, a user who has just parked his car and is walking to a meeting may not want anyone who peeks to think he is still driving, but rather wants them to know that he is walking to the meeting. If so, step 508 updates the cache with the context data (e.g., associated with the request) by branching to step 510.

Step 512 represents checking for another type of request, referred to as a broadcast; (if not a broadcast, step 514 handles other types of requests not shown, e.g., changes to the settings, audit requests, and so on as described with reference to FIG. 2). Broadcast requests are those in which a user wants to send out context information as if the user was peeked at, without waiting for an actual peek request. For example, a user who is late to a meeting may want to broadcast that he is walking towards the meeting room. A user who is just back from college may want to let her friends know she is now in town.

For broadcast requests, the cache is updated via step 516. Step 518 represents obtaining the set of recipients for the broadcast, which may be everyone the user specified or one or more individual identities and/or a class of users (e.g., coworkers in the above meeting example, friends in the back-in-town example). Step 520 represents sending the context data, which may be performed for each user via steps 418, 420 and 422 of FIG. 4 as described above, for example; note that normal filtering and message adjustment thus may apply, (and logging at step 424 may record the broadcast to each recipient or as a whole). Thus, although step 422 refers to a “response,” it is understood that in a broadcast context the term “response” includes sending a broadcast message, not as a response to a requesting entity, but sent in response to the broadcast request. Further, note that for efficiency it may be desirable to identify a class/batch broadcasts rather than filter/adjust per individual recipient, e.g., if a user wants to broadcast context information to a class of users, then the class may be named the recipient such that each user in that class receives the same context message. Note that the same filtering/message adjustment criteria and rules may apply to the whole class, or the criteria applied to the least-shared-with member of that class applied to everyone for a batched message.

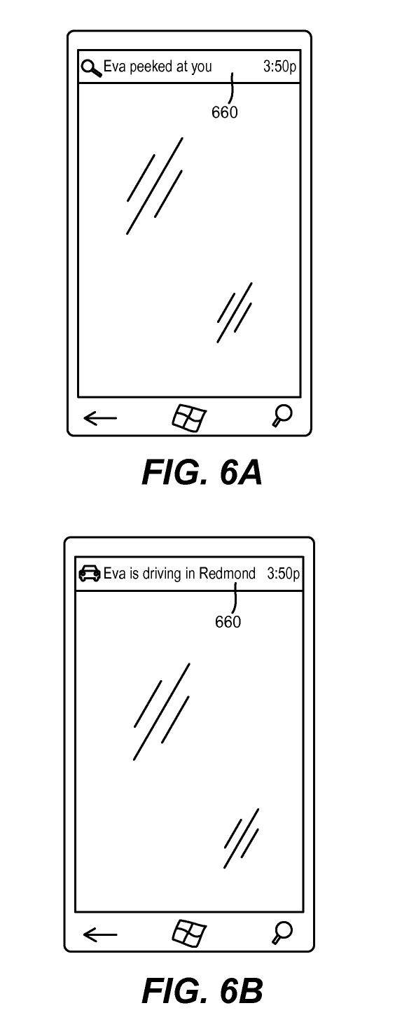

FIGS. 6A-8B are example representations of a device and its display screens in various scenarios. In FIG. 6A, the device shows a notification 660 that someone (named “Eva” in this simplified example) has peeked at the user, along with the time the peek occurred. In FIG. 6B as shown as the notification 662, the user named “Eva” has pushed her status, or provided it as part of reciprocity in order to obtain the peeked-at data.

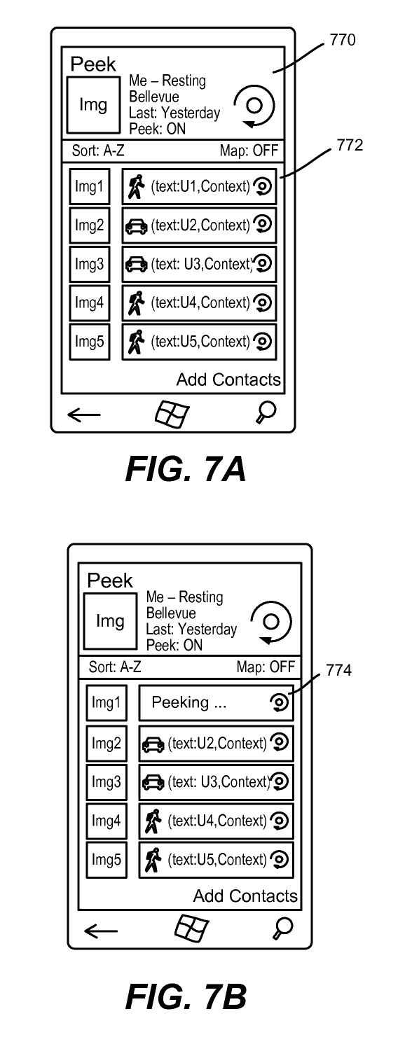

FIGS. 7A and 7B are directed to example user interface representations that appear when the context sharing service (peek program) is run on the example device. In FIG. 7A, the user sees his or her own status in a screen area 770, e.g., accompanied by an image (Img), and some text corresponding to the current context. In this user experience, the user can see the contexts of other users, e.g., via their images Img1-Img5, and text of their identities U1-U5 and current context data; (actual names and context data are shown in an actual implementation). Also shown is a status icon corresponding to the other users' context, e.g., in the form of a car for driving, a figure walking, and so forth.

In FIG. 7B, the user has contacted the area 774 (or some part thereof, such as the circular arrow region) causing the device to request a peek of the user U1 corresponding to that area. The area indicates that peeking is occurring.

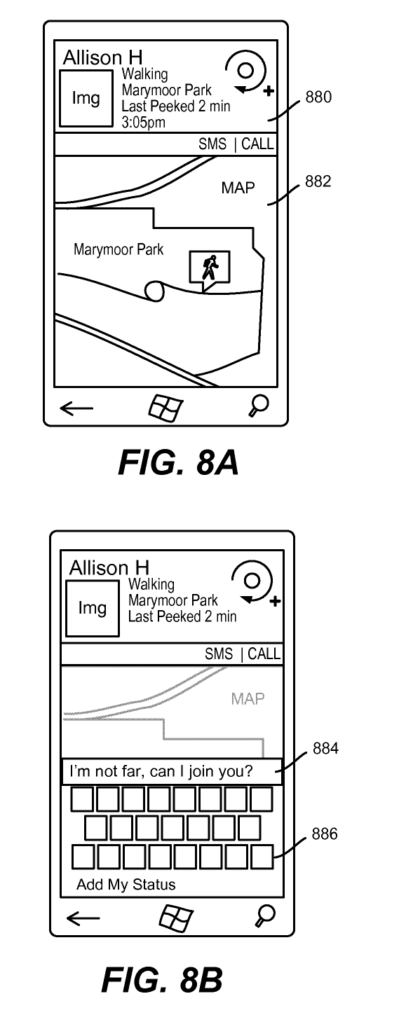

In FIG. 8A, the peeked-at user's identity (shown as Allison H instead of user U1) and actual context data appears in the area 880. In this example, a map is shown in the screen area 882 showing the peeked-at user's reported current location; (when peeked-at context includes location data, the map may be shown via user additional interaction, or may be automatically shown).

In FIG. 8B, the user is able to easily communicate with the peeked-at user, e.g., by interacting with the context sharing service program. While SMS/text messaging is one possibility for communication, the context sharing service may also use peek-related notifications to send content, such as text 884 entered via a popup keyboard 886 without exiting the program.

Turning to another aspect, while the above examples are directed towards entities comprising people peeking at other people's context, users may grant permissions to other entities to peek at them. By way of example, a user may have a communications program peek the user's context so as to automatically divert calls to voicemail or a secretary when the user is driving, dealing with clients (e.g., as determined from a noisy environment and calendar data), and so forth. A home automation system may peek a user's context so as to turn on the heat as the user is coming home. A doctor's medical program may peek to see how often a particular patient is walking, so as to raise an alert if not what was recommended. Thus, as used herein, a “peek” request with respect to any entity's action refers to requesting the context, and if context-related data is returned, the consumption of the data by a human or machine does not necessarily need any visual activity on the part of the peeking entity.

Note that in such cases (and any others the user desires), the user may selectively turn off the automatic notification that indicates that the peek request occurred. In this way, for example, a user may receive notifications when other people peek at their context data, but not when a home automation system does so (where one-way “spying” is acceptable and more desirable than getting many mostly useless notifications).

As can be readily appreciated, in addition to convenience, other uses of the technology described herein may be implemented. For example, a trucking company may have a program peek its drivers' devices to inexpensively monitor their locations and speeds. Such data may provide insurance benefits, benefits with coordinating new pickups, and so forth without the expense of having to install custom hardware tracking devices and the like. Bicycles and foot couriers are also able to benefit using cell phones or the like that they already possess.

As can be seen, there is provided a technology for automatically requesting context information from a device, which may include physical activity (resting, driving, walking), location, current application in use, calendar data, and so forth in a privacy-respectful manner. This device software determines the contextual information and provides the contextual information to the requesting user, as well as provides a user experience notifying the user they have shared context information. The technology facilitates the automatic sharing of contextual information (beyond mere location data) to pre-approved requesters, and indeed may exclude location data. The technology provides privacy via notifications to users when they have automatically shared information, and a history mechanism for auditing sharing. Still further, applications running in the cloud or on remote devices (or even the device itself) may peek at the context and take automated actions based on the peeked status.

### Example Operating Environment

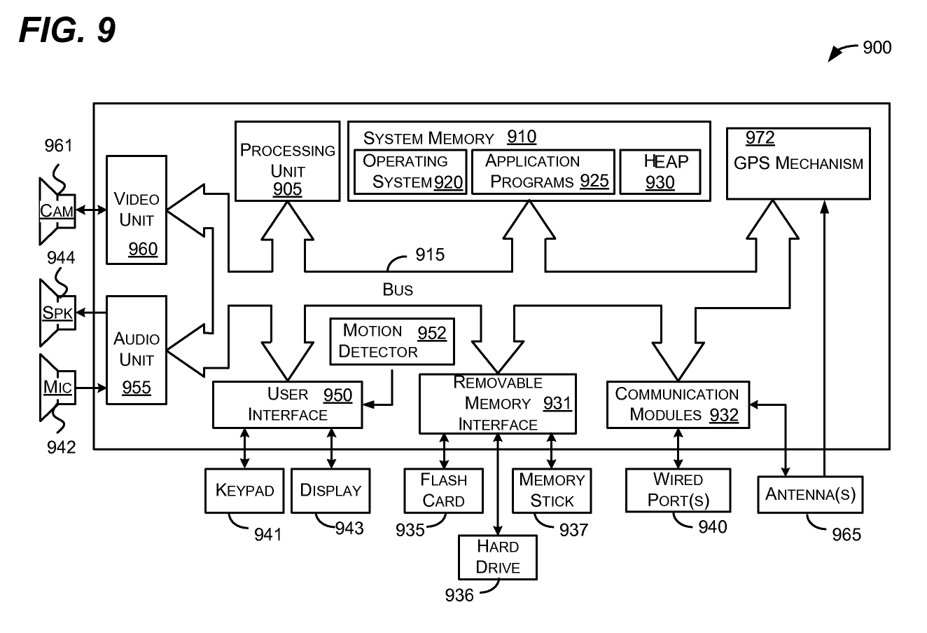

FIG. 9 illustrates an example of a suitable mobile device 900 on which aspects of the subject matter described herein may be implemented. The mobile device 900 is only one example of a device and is not intended to suggest any limitation as to the scope of use or functionality of aspects of the subject matter described herein. Neither should the mobile device 900 be interpreted as having any dependency or requirement relating to any one or combination of components illustrated in the example mobile device 900.

With reference to FIG. 9, an example device for implementing aspects of the subject matter described herein includes a mobile device 900. In some embodiments, the mobile device 900 comprises a cell phone, a handheld device that allows voice communications with others, some other voice communications device, or the like. In these embodiments, the mobile device 900 may be equipped with a camera for taking pictures, although this may not be required in other embodiments. In other embodiments, the mobile device 900 may comprise a personal digital assistant (PDA), hand-held gaming device, notebook computer, printer, appliance including a set-top, media center, or other appliance, other mobile devices, or the like. In yet other embodiments, the mobile device 900 may comprise devices that are generally considered non-mobile such as personal computers, servers, or the like.

Components of the mobile device 900 may include, but are not limited to, a processing unit 905, system memory 910, and a bus 915 that couples various system components including the system memory 910 to the processing unit 905. The bus 915 may include any of several types of bus structures including a memory bus, memory controller, a peripheral bus, and a local bus using any of a variety of bus architectures, and the like. The bus 915 allows data to be transmitted between various components of the mobile device 900.

The mobile device 900 may include a variety of computer-readable media. Computer-readable media can be any available media that can be accessed by the mobile device 900 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the mobile device 900.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, Bluetooth®, Wireless USB, infrared, Wi-Fi, WiMAX, and other wireless media. Combinations of any of the above should also be included within the scope of computer-readable media.

The system memory 910 includes computer storage media in the form of volatile and/or nonvolatile memory and may include read only memory (ROM) and random access memory (RAM). On a mobile device such as a cell phone, operating system code 920 is sometimes included in ROM although, in other embodiments, this is not required. Similarly, application programs 925 are often placed in RAM although again, in other embodiments, application programs may be placed in ROM or in other computer-readable memory. The heap 930 provides memory for state associated with the operating system 920 and the application programs 925. For example, the operating system 920 and application programs 925 may store variables and data structures in the heap 930 during their operations.

The mobile device 900 may also include other removable/non-removable, volatile/nonvolatile memory. By way of example, FIG. 9 illustrates a flash card 935, a hard disk drive 936, and a memory stick 937. The hard disk drive 936 may be miniaturized to fit in a memory slot, for example. The mobile device 900 may interface with these types of non-volatile removable memory via a removable memory interface 931, or may be connected via a universal serial bus (USB), IEEE 9394, one or more of the wired port(s) 940, or antenna(s) 965. In these embodiments, the removable memory devices 935-937 may interface with the mobile device via the communications module(s) 932. In some embodiments, not all of these types of memory may be included on a single mobile device. In other embodiments, one or more of these and other types of removable memory may be included on a single mobile device.

In some embodiments, the hard disk drive 936 may be connected in such a way as to be more permanently attached to the mobile device 900. For example, the hard disk drive 936 may be connected to an interface such as parallel advanced technology attachment (PATA), serial advanced technology attachment (SATA) or otherwise, which may be connected to the bus 915. In such embodiments, removing the hard drive may involve removing a cover of the mobile device 900 and removing screws or other fasteners that connect the hard drive 936 to support structures within the mobile device 900.

The removable memory devices 935-937 and their associated computer storage media, discussed above and illustrated in FIG. 9, provide storage of computer-readable instructions, program modules, data structures, and other data for the mobile device 900. For example, the removable memory device or devices 935-937 may store images taken by the mobile device 900, voice recordings, contact information, programs, data for the programs and so forth.

A user may enter commands and information into the mobile device 900 through input devices such as a key pad 941 and the microphone 942. In some embodiments, the display 943 may be touch-sensitive screen and may allow a user to enter commands and information thereon. The key pad 941 and display 943 may be connected to the processing unit 905 through a user input interface 950 that is coupled to the bus 915, but may also be connected by other interface and bus structures, such as the communications module(s) 932 and wired port(s) 940. Motion detection 952 can be used to determine gestures made with the device 900.

A user may communicate with other users via speaking into the microphone 942 and via text messages that are entered on the key pad 941 or a touch sensitive display 943, for example. The audio unit 955 may provide electrical signals to drive the speaker 944 as well as receive and digitize audio signals received from the microphone 942.

The mobile device 900 may include a video unit 960 that provides signals to drive a camera 961. The video unit 960 may also receive images obtained by the camera 961 and provide these images to the processing unit 905 and/or memory included on the mobile device 900. The images obtained by the camera 961 may comprise video, one or more images that do not form a video, or some combination thereof.

The communication module(s) 932 may provide signals to and receive signals from one or more antenna(s) 965. One of the antenna(s) 965 may transmit and receive messages for a cell phone network. Another antenna may transmit and receive Bluetooth® messages. Yet another antenna (or a shared antenna) may transmit and receive network messages via a wireless Ethernet network standard.

Still further, an antenna provides location-based information, e.g., GPS signals to a GPS interface and mechanism 972. In turn, the GPS mechanism 972 makes available the corresponding GPS data (e.g., time and coordinates) for processing.

In some embodiments, a single antenna may be used to transmit and/or receive messages for more than one type of network. For example, a single antenna may transmit and receive voice and packet messages.

When operated in a networked environment, the mobile device 900 may connect to one or more remote devices. The remote devices may include a personal computer, a server, a router, a network PC, a cell phone, a media playback device, a peer device or other common network node, and typically includes many or all of the elements described above relative to the mobile device 900.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term server may be used herein, it will be recognized that this term may also encompass a client, a set of one or more processes distributed on one or more computers, one or more stand-alone storage devices, a set of one or more other devices, a combination of one or more of the above, and the like.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A method comprising:
receiving a peek request for context-related information corresponding to a user's activity, the request associated with a requestor identity;
determining whether the requestor identity is valid, and if so, automatically returning a response based at least part on context data in response to the peek request; and
taking action that indicates that the peek request for context-related information was made by an entity corresponding to the requestor identity.

2. The method of claim 1 wherein taking action that indicates that the peek request for context-related information was made comprises providing a notification for output by a device.

3. The method of claim 1 wherein taking action that indicates that the peek request for context-related information was made comprises recording information in an audit data structure.

4. The method of claim 1 further comprising, filtering the device context data into filtered context-related data based upon one or more filtering criteria.

5. The method of claim 4 further comprising, adjusting the response based upon the filtered context-related data.

6. The method of claim 1 further comprising, communicating with one or more devices to obtain the device context data.

7. The method of claim 1 further comprising, communicating with one or more devices to obtain the device context data and caching the device context data in a cache, and wherein automatically returning the response comprises retrieving the context data from the cache, and processing the context data into the response.

8. The method of claim 1 further comprising, at one or more devices, processing information obtained from a plurality of device sensors into activity-related information, and including the activity-related information in the device context data.

9. The method of claim 8 further comprising, enhancing the device context data using cached contexts from a plurality of users.

10. The method of claim 1 further comprising, receiving a broadcast request from a device, and outputting context-related data to at least one recipient in response to the broadcast request.

11. The method of claim 1 further comprising, basing the response at least in part on whether the request is associated with reciprocal context-related information.

12. The method of claim 1 wherein automatically returning the response based at least part on context data in response to the peek request comprises returning a response indicating that peeking is turned off.

13. A system comprising, one or more processors and a memory, the one or more processors configured to execute code in the memory, the code corresponding to a context sharing service that when executed is configured to receive context data corresponding to a user's activity as determined via one or more devices, to process the context data into context-related information based upon an identity of a valid recipient and one or more filtering criteria associated with the identity, to send the context-related information to a recipient machine, and to take action to indicate that the context-related information was sent.

14. The system of claim 13 wherein the context sharing service is a remote service relative to the one or more devices, and is further configured to cache the context data.

15. The system of claim 13 wherein the one or more filtering criteria comprise location-related criteria, time-related criteria, context-related criteria from at least one other user, or device-related criteria, or any combination of location-related criteria, time-related criteria, context-related criteria from at least one other user, or device-related criteria.

16. The system of claim 13 wherein the context data comprises activity-related data determined from information sensed at the one or more devices.

17. The system of claim 13 wherein the context sharing service is configured to send the context-related information to the recipient machine in response to a peek request from the recipient machine, or to send the context-related information to the recipient machine in response to a broadcast request from one of the one or more devices.

18. The system of claim 13 wherein the action comprises a notification sent to the one or more devices, or information written to an audit data structure, or both a notification sent to the one or more devices and information written to an audit data structure.

19. The system of claim 13 wherein the valid recipient corresponds to a user of the recipient machine, or a computer program executing at least in part on the recipient machine.

20. One or more computer-readable media having computer-executable instructions, which when executed perform steps, comprising:
receiving a peek request for context-related information corresponding to a user's activity, the request associated with a requestor identity;
determining whether the requestor identity is valid, and:
if not valid, terminating the peek request with no response or a denied response, or
if valid, filtering context data obtained from one or more devices based upon filtering criteria set associated with the requestor identity into filtered context-related data, returning a response to the peek request, the response based upon the context-related data, notifying one or more of the one or more devices that the peek request was made, and recording information related to the peek request and response.
